(19) United States
(12) Patent Application Publication
(10) Pub. No.: US 2006/0082552 A1
(43) Pub. Date: Apr. 20, 2006

(54) Mouse with audio output function

(75) Inventor: Li-Chin Chen, San -Chung City (TW)

Correspondence Address: TROXELL LAW OFFICE PLLC, SUITE 1404, 5205 LEESBURG PIKE, FALLS CHURCH, VA, 22041, US

(73) Assignee: Scythe Taiwan Co., Ltd.

(21) Appl. No.: 10/965,885

(22) Filed: Oct. 18, 2004

(51) Int. Cl. G09G 5/08

(52) U.S. Cl. 345/163

(57) ABSTRACT

A mouse with audio output function includes a control circuit, a volume control for adjusting high/low level of audio signals, an ON/OFF switch for supplying or cutting off power output from the control circuit, an amplifying circuit for amplifying audio signals, and a sound output device. A terminal is connected to an audio output on a computer to transmit audio signals from the computer to the amplifying circuit in the mouse. The audio signals amplified at the amplifying circuit are output via the sound device as sound. The mouse can therefore replace conventional sound playing devices and allows a user to enjoy sound from the computer without the need of installing separate speakers. Moreover, the mouse is directly supplied with power from the computer without the need of an external power source to drive the audio output function, and could be conveniently carried along with the user for use at different places.

### FIELD OF THE INVENTION

The present invention relates to a mouse with audio output function, and more particularly to a mouse having internal amplifier and speaker to amplify audio signals received from an electronic apparatus and output the amplified signals as sound without the need of installing separate speakers or connecting to an external power source, making the mouse a conveniently movable sound playing device.

### BACKGROUND OF THE INVENTION

Externally connected speaker and built-in speaker are two major or types of sound playing devices for computers, and are well-known among general industrial fields and most consumers. The externally connected speaker is particularly common for use, and is connected to an audio socket on the computer via a connecting terminal, so as to transmit audio signals from the computer to the speaker to output sound.

To drive the externally connected speaker, the speaker must be connected to an external power source and would therefore occupy a power socket and consume a relatively large amount of current to increase the work load of the power socket. Since there are more and more peripherals connected to the computer, it is very possible to cause unsteady power supply that results in insufficient voltage or even tripping off of the peripherals. The computer and the peripherals thereof would be damaged after being used under this condition for a long time.

Moreover, the externally connected speaker has a relatively large volume and sometimes includes an amplifier to cause inconveniences to the user when it is desired to use the speaker outdoors. The complicate wiring also limits the externally connected speaker to be used indoor.

For some multi-media apparatus, the speakers are built in the apparatus. Since the built-in speaker has magnetic elements that tend to affect other peripherals, such as monitor and the like, that are easily magnetically interfered, and thereby produces mutual interference between the speaker and other peripherals and results in noises or distortion of sound output from the built-in speaker, forming another confusion to the user.

It is therefore tried by the inventor to eliminate the drawbacks existed in the conventional sound output apparatus.

### SUMMARY OF THE INVENTION

A primary object of the present invention is to provide a mouse with audio output function, so that a sound output device is directly built in the mouse to omit externally connected speakers and reduce the cost for purchasing multi-media apparatus.

Another object of the present invention is to provide a mouse with audio output function, so that an amplifier built in the mouse is able to create best audio output effect and achieve largely upgraded sound quality.

A further object of the present invention is to provide a mouse with and output function, so that audio signals transmitted to and output from the mouse could be adjusted in volume and cut off as needed using volume control and ON/OFF switch provided on the mouse, in order to avoid adverse influence on the user's working environment.

A still further object of the present invention is to provide a mouse with audio output function, go that power supplied from a computer to the mouse could be indirectly supplied via a control circuit of the mouse to a sound output device and other audio output elements built in the mouse. As a result, the sound output device and other audio output elements in the mouse could be driven to work without the need of connecting to an external power source. Power consumption for effectuating the audio output function is therefore reduced.

To achieve the above and other objects, the mouse with audio output function according to the present invention mainly includes a control circuit, a volume control for adjusting high/low level of audio signals, an ON/OFF switch for supplying or clotting off power output from the control circuit, an amplifying circuit for amplifying the audio signals, and a sound output device. A terminal extended from the mouse is connected to an audio output on a computer to transmit audio signals from the computer to the amplifying circuit in the mouse. The audio signals amplified at the amplifying circuit are output via the sound output device ds sound. The mouse could be used to replace conventional sound playing apparatus and allows a user to enjoy sound from the computer without the need of installing separate speakers. Moreover, the mouse is supplied with power from the computer without the need of connecting to an external power source for driving the audio output function, and could be conveniently carried along with the user for use at different places.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram showing the arrangement of different audio output elements in a mouse with audio output function according to the present invention;

FIG. 2 is an exploded perspective view of the mouse with audio output function according to the present invention;

FIG. 3 is an assembled perspective view of FIG. 2;

FIG. 4 is a perspective view showing the connection of the mouse of the present invention to a computer; and

FIG. 5 is a block diagram showing the audio output function of the mouse of the present invention is switched off.

### DETAILED DESCRIPTION OF THE PREFERRED EMBODIMENTS

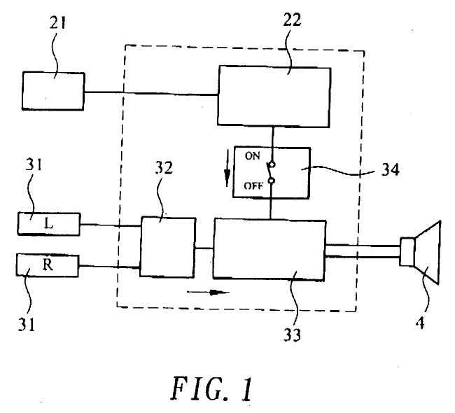

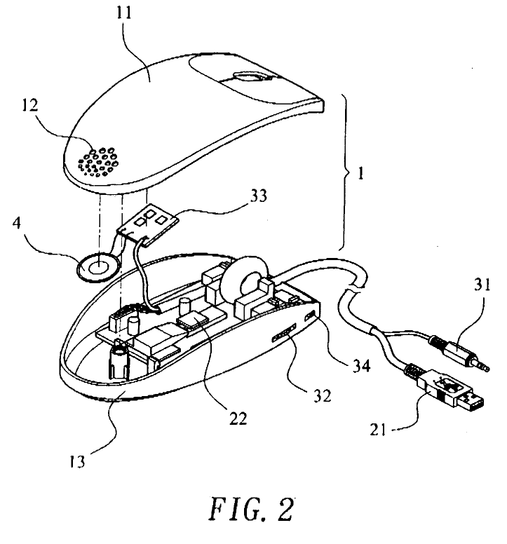

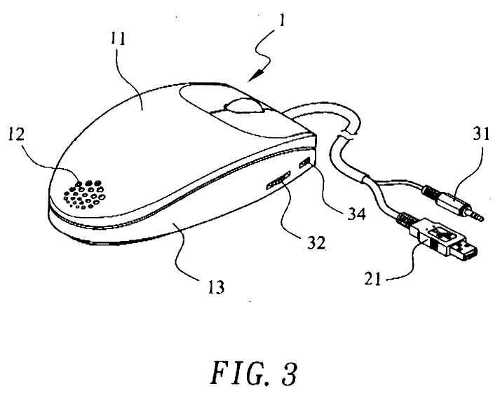

Please refer to FIG. 1 that is a block diagram showing the arrangement of different audio output elements in a mouse with audio output function 1 according to the present invention; and to FIGS. 2 and 3 that are exploded and assembled perspective views, respectively, of the mouse with audio output function 1.

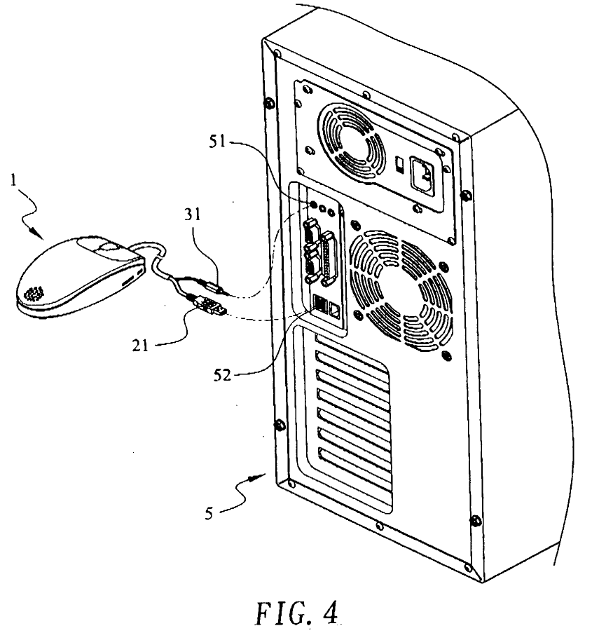

As shown, the mouse with audio output function 1 according to the present invention includes a control circuit 22 for sending control signals to a central processing unit of a computer 5 (see FIG. 4) and thereby controlling movement of a cursor of the computer 5. A connection interface 21, which may be a USB interface or a PS/2 interface, is extended from an end of the control circuit 22 to connect to the computer 5 for transmitting the control signals to the computer 5 and supplying working current from the computer 5 to the mouse 1 (see FIG. 4), and an ON/OFF switch 34 is connected to another end of the control circuit 22 to locate between the control circuit 22 and an amplifying circuit 33 for supplying or cutting off a power output by the control circuit 22.

The amplifying circuit 33 amplifies audio signals and the amplified audio signals are output as sound via a sound output device 4.

A volume control 32 is connected to the amplifying circuit 33 for regulating high/low level of the audio signals, and has a terminal 31 extended from an end thereof for connecting to an audio jack 51 on the computer 5 (see FIG. 4), so as to transmit audio signals from the computer 5 to the volume control 32.

The sound output device 1, which may be a speaker, is connected to the amplifying circuit 33 to output sound.

As can be seen from FIGS. 2 and 3, the mouse 1 is provided at a rear end of a cover 11 located above a main body 113 or the mouse 1 with a plurality of round holes 12, via which sound output from the sound output device 4 is diffused, so that a user could enjoy sound effect while operating the computer 5 via the mouse 1.

Please refer to FIGS. 1 and 4 at the same time. To use the mouse 1, the user needs only to plug the connection interface 21 to a USB port 52 on the computer 5 and plug the terminal 31 to the audio jack 51 on the computer 5, and then powers on the computer 5 to drive the mouse 1. When it is desired for the mouse 1 to play sound from the computer 5, the user needs only to switch the ON/OFF switch 34 to the ON position, and power supplied by the control circuit 22 is sent to the volume control 32, the amplifying circuit 33, and the sound output device 4 as working power of these elements. Audio signals are then led in via the terminal 31 and sent to the amplifying circuit 33 via the volume control 32. The audio signals are amplified at the amplifying circuit 33 and then sent to the sound output device 4, from where sound is output. The user may use the volume control 32 to finely adjust the volume of sound output from the sound output device 4.

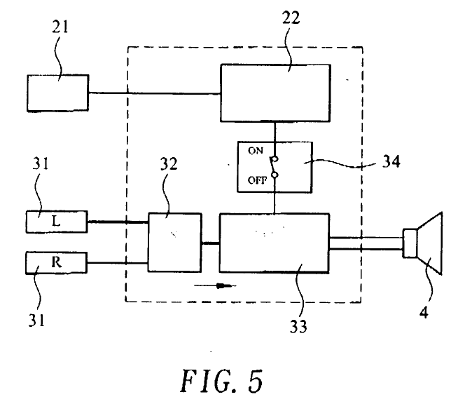

When it is desired or necessary to pause or cease playing sound via the mouse 1, the user needs only to switch the ON/OFF switch 34 to the OFF position to cut off the power supplied by the control circuit 22. At this point, the volume control 32, the amplifying circuit 33, and the sound output device 4 are disabled, and the sound played via the sound output device 4 is stopped. FIG. 5 is a block diagram of the mouse 1 showing the ON/OFF switch 34 is switched off.

With the above arrangements, the mouse 1 of the present invention could be used to output sound simply by connecting the terminal 31 to the audio output on the computer 5, and audio signals are transmitted from the computer 5 to the amplifying circuit 33 and amplified before being output via the sound output device 4. It is not necessary for the user to install separate speakers. That is, conventional sound playing devices externally connected to a computer for outputting audio signals from the computer could now be replaced with the mouse 1 of the present invention. Moreover, power needed to output audio signals via the mouse 1 could be directly supplied from the control circuit 22 of the mouse 1 without the need of connecting the mouse 1 to an external power source. The sound output could be conveniently adjusted to a desired volume or cut off according to actual needs, so that the sound output via the sound output device 4 does not adversely affect the user's work over the computer 5. The mouse 1 could also be conveniently carried along with the user for the user to enjoy audio output at different places.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A mouse with audio output function, comprising:
an ON/OFF switch for supplying or cutting off power supplied from a control circuit of said mouse;
an amplifying circuit for amplifying audio signals;
a volume control for adjusting high/low level of said audio signals;
a terminal for transmitting said audio signals; and
a sound output device for outputting sound.

2. The mouse with audio output function as claimed in claim 1, wherein said sound output device is a speaker.

3. A mouse with audio output function, comprising:
a control circuit for sending control signals to a central processing unit of a computer, to which said mouse is connected, so as to control movements of a cursor of said computer;
a connection interface via which said control signals and a working power for said mouse are transmitted from said computer to said mouse;
an amplifying circuit for amplifying audio signals;
a volume control for adjusting high/low level of said audio signals;
a terminal via which said audio signals are transmitted from said computer to said mouse; and
a sound output device for outputting sound.

4. The mouse with audio output function as claimed in claim 3, wherein said connection interface is a USB interface.

5. The mouse with audio output function as claimed in claim 3, wherein said connection interface is a PS/2 interface.

6. The mouse with audio output function as claimed in claim 3, wherein said sound output device is a speaker.
